(19) United States
(12) Patent Application Publication
(10) Pub. No.: US 2003/0074309 A1
(43) Pub. Date: Apr. 17, 2003

(54) Method for promoting a mortgage lending service

(76) Inventors: Christopher V. Arnold, Cincinnati, OH (US); Wendell T. Cassidy, Mason, OH (US); Gregory C. Fail, Middletown, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 09/976,947

(22) Filed: Oct. 12, 2001

(51) Int. Cl. G06F 17/60

(52) U.S. Cl. 705/38

(57) ABSTRACT

A method for promoting a mortgage lending service that includes the step of offering, by a mortgage lending service, free use of a moving van upon the establishment of mortgage financing with the mortgage lending service. The method may also include the step of, in association with the step of establishing mortgage financing with the customer, providing the customer with use of a moving van for moving into the property financed by the mortgage lending service.

### BACKGROUND

The present invention is directed to a method for conducting business; and more particularly, to a method for promoting a mortgage lending service.

### SUMMARY

The first aspect of the present invention is to provide a method for promoting a mortgage lending service that includes the steps of: (a) establishing mortgage financing with the customer; and (b) in association with the step of establishing mortgage financing with the customer, providing the customer with use of a moving van. In a more detailed embodiment, the moving van is provided to the customer by the mortgage lending service at no additional charge. In an alternate detailed embodiment, the method further includes the step of advertising the mortgage lending service on outer faces of the moving van. In yet another alternate detailed embodiment, the method further includes the step of providing, at no additional charge, an appliance dolly, moving mats and/or fuel for the moving van.

It is the second aspect of the present invention to provide a method for promoting a mortgage lending service that includes the step of offering, by a mortgage lending service, free use of a moving van upon the establishment of mortgage financing with the mortgage lending service.

### BRIEF DESCRIPTION OF THE DRAWINGS

FIG. 1 is a flow diagram representing a method according to an exemplary embodiment of the present invention.

### DETAILED DESCRIPTION

The present invention is directed to a method for conducting business; and more particularly, to a method for promoting a mortgage lending service that includes the step of offering, by a mortgage lending service, free use of a moving van upon the establishment of mortgage financing with the mortgage lending service.

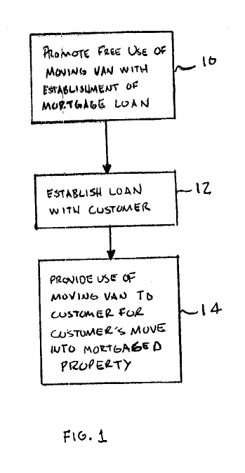

Referring to FIG. 1, in an exemplary embodiment, as shown in step 10, a mortgage lending company promotes the free use of a moving van to a customer if the customer establishes a mortgage loan with the mortgage lending company. In step 12, the customer establishes a mortgage loan with the mortgage lending company. And in step 14, the customer is provided with a free 14-foot moving truck (with ramp) by the mortgage lending company. In this exemplary embodiment, the customer is also provided with the use of a appliance dolly, and moving mats. Furthermore, the mortgage lending company provides the moving van to the customer with a full tank of gasoline. The customer is permitted to utilize the moving van and related items during the customer's move into the residence for which the mortgage financing was secured.

Furthermore, in the exemplary embodiment, the mortgage lending company advertises its services, as well as this moving van service on the surfaces of the moving van itself. Therefore, when the customer utilizes the moving van within a community, the mortgage lending company is also being promoted throughout the community. The mortgage lending company also promotes the free moving van service in its promotional and advertising materials. Furthermore, realtors associated with the mortgage lending company promote the use of this moving van service because it provides the realtor with a competitive advantage over other realtors that are not associated with the mortgage lending company offering the use of the moving van.

Accordingly, if a realtor gives a customer three lenders to choose from and all three have the same rate and closing costs, which is often the case, the home buyer will likely choose the mortgage lending company that offers the use of the free moving van service. This service saves the customer the additional expense and hassle of securing a moving van, especially during the latter days of a particular month when most moving van rental services are booked.

While, in the exemplary embodiment, the moving van is provided by the mortgage lending service, free of charge, it is within the scope of the invention that the mortgage lending company offer the moving van at a very small charge (which would preferably be much less than the cost of renting a moving van from a rental company); and it is also within the scope of the invention that the mortgage lending company provide the free (or low cost) moving van through an arrangement with a third-party rental company or a moving service. In other words, it is not necessary that the mortgage lending service provide the moving van for free and it is not necessary that the mortgage lending service own the moving van.

What is claimed is:

1. A method for promoting a mortgage lending service comprising the steps of:
establishing mortgage financing with a customer; and in association with the step of establishing mortgage financing with the customer, providing the customer with use of a moving van.

2. The method of claim 1, wherein the moving van is provided to the customer at no additional charge.

3. The method of claim 1, further comprising the step of advertising the mortgage lending service on outer faces of the van.

4. The method of claim 1, further including the step of providing, at no additional charge, one or more of the following:
an appliance dolly;
moving mats; and
fuel for the moving van.

5. A method for promoting a mortgage lending service comprising the step of offering, by a mortgage lending service, free use of a moving van upon the establishment of mortgage financing with the mortgage lending service.
